(19) United States
(12) Patent Application Publication
(10) Pub. No.: US 2010/0042659 A1
(43) Pub. Date: Feb. 18, 2010

(54) DEPLOYMENT OVERVIEW MANAGEMENT SYSTEM, APPARATUS, AND METHOD

(75) Inventor: JOHN F. ROSE, TURRAMURRA (AU)

Correspondence Address: HEWLETT-PACKARD COMPANY;Intellectual Property Administration, 3404 E. Harmony Road, Mail Stop 35, FORT COLLINS, CO, 80528, US

(73) Assignee: ELECTRONIC DATA SYSTEMS CORPORATION, PLANO, TX (US)

(21) Appl. No.: 12/192,637

(22) Filed: Aug. 15, 2008

(51) Int. Cl. G06F 17/30

(52) U.S. Cl. 707/201; 707/E17.005

(57) ABSTRACT

A deployment overview management system, method, and associated apparatus facilitates deployment of a computer system. Feedback is provided to the deployment overview management system by prior-deployed, and other, computer systems. The feedback forms metadata that is associated with active objects, processes, and systems. The metadata is utilized to facilitate deployment of a new system and management of an existing system.

The present invention relates generally to a manner by which to facilitate deployment, and operation, of an object-based, or other, computer system. More particularly, the present invention relates to an apparatus, system, and method for managing and overviewing deployment of a computer system, such a computer system deployed by another deployment system. Metadata is collected and used pursuant to the computer-system deployment and management.

Selection of deployment operations takes advantage of actual experience, reported in the form of feedback, that is stored as metadata associated with objects, processes, and prior-deployed systems.

### BACKGROUND OF THE INVENTION

For many, ready access to computers is a practical necessity. Many business, and other, enterprises require, for their operation, the availability of their personnel to access and use computers to carry out enterprise activities.

Many times, computers are interconnected to form networks of computers and computer-related devices. When interconnected, network connections provide for the communication of information between the interconnected computers. Both local area networks (LANs), wireless local area networks (WLANs), and wide area networks (WANs), and their associated communication protocols and technologies, permit large amounts of data to be communicated between the network-connected computers, even when separated by large distances.

A business, or other, enterprise that utilizes computers and computer systems regularly must make upgrades to, and purchase new, computer systems. Such upgraded and new computer systems take advantage of evolving technologies and newly-created systems, applications and other components. A large number of computer-system and component providers provide many different types of computer systems and products, and they represent a significant portion of today's economic marketplace. While many computer-system, and related, systems and software applications are developed in manners permitting their off-the-shelf purchase, other systems are developed to meet specific customer needs. That is to say, the system is tailored to meet the specific needs of the purchasing enterprise.

When the computer system is complex, requiring a large number of software objects to carry out a significant number of tasks and operations, system development and implementation becomes a complex and challenging activity.

When a computer-system provider or manager is encharged with the development of a system architecture, significant efforts must therefore be expended in order to develop, deploy, and manage the computer system in conformity with the customer requirements. While relatively simple development tasks are carried out efficiently by an individual or a small group of developers, when the development task is large, the development is carried out by a large number of developers, sometimes grouped into different development groups, each responsible for developing different portions of the system. Coordination between the separate groups, developing the different portions of the computer system is, of course, needed to ensure that the development by the different groups is carried out correctly and timely. Coordination is needed, for instance, to match the resources available for the system development and deployment with the development and deployment tasks that are to be carried out. The coordination, as well as the underlying development, is complicated when short time frames are required. That is to say, when the development and deployment must meet imminent deadlines, system development and its coordination is made more difficult.

While system-development entities often times have significant experience in the development of systems, full advantage of such experience is typically not fully taken. And, as a result, development is sometimes unduly inflexible. The coordination is sometimes primarily, or exclusively, reliant upon the knowledge of a single group of, or small group of, personnel, relying upon their collective knowledge. Sometimes, the knowledge of the personnel is dated and does not include most-recent information that might be available. And, the collective knowledge of the small group of personnel is inherently qualitative in nature.

Once the requirements of the computer system are defined, the system developer must develop the system that operates in manners that achieve the system requirements. Often times, the system is formed of a plurality of software objects of an object-oriented software scheme. The objects are sometimes not newly-created and are, instead, merely modified or combined together to meet the goals of the system implementation. Interaction between the objects sometimes has a history, but the history is not easily available to personnel that coordinate the system development and deployment.

If an improved manner could be provided by which to maintain and use information associated with prior computer-system deployment and experience, improved development, deployment, and ongoing system management would be possible.

It is in light of this background information related to computer-system development, deployment, and management that the significant improvements of the present invention have evolved.

### SUMMARY OF THE INVENTION

The present invention, accordingly, advantageously provides an apparatus, system, and method by which to facilitate deployment, and operation, of an object-based, or other, computer system.

Through operation of an embodiment of the present invention, a manner is provided by which to manage an overview deployment of a computer system. An active repository is maintained that contains active objects and metadata that are usable in the selection and deployment and modification of a computer system.

In one aspect of the present invention, a deployment overview management system is provided that maintains an active repository of meta-data associated with, or in the context of, each deployment. Metadata is collected as feedback from prior-deployed, and other, systems during their operation. Metadata is collected and maintained associated with any aspect of a system, including any processor object thereof.

In another aspect of the present invention, documentation support, e.g., in the form of templates, guides, etc., is also provided for the performance of manual tasks. The documents provided pursuant to the documentation support, comprise, or are formed, making use of, the repository-stored metadata.

In another aspect of the present invention, generated scripts and action automated tasks are provided to analyze, make progress reports and monitor performance of processes.

In another aspect of the present invention, the performance of a deployment system or process is matched to expectations of the end users. When appropriate, pre-determined contingency actions are activated and coordinated.

In another aspect of the present invention, control of a complete deployment process is provided. And, analogously, coordination of a system deployment and its optimization is also provided. Multiple sub-systems are used, using, e.g., multiple platforms, located in disparate geographical locations.

In another aspect of the present invention, a deployment overview management system is provided that acts as a facilitator in a system deployment. The deployment overview management system is usable by deployment personnel working at disparate locations who are able to use the system even when conversant in different, spoken languages. That is to say, the system is usable by personnel who speak and understand dissimilar languages.

In another aspect of the present invention, feedback is provided by active objects and processes that have been deployed. The feedback is used to build-up process experience, and the collection of the feedback provides for predicted analysis of time-to-do processes, cost simulation, resource planning, capacity planning, etc. The feedback is, e.g., iterative, both at an object level and at a process level. The feedback of a process is used, e.g., to refine the next iteration of the process.

In another aspect of the present invention, operational experience is captured and forms feedback that is used to provide collections of workarounds, tips to follow, etc. For SME (small and medium enterprises), and others, to utilize. The collected experiences, e.g., immediately used to refine current and future deployments. Because the experience is collected and maintained, experience information in feedback is able to be used to leverage previous work, e.g., work pursuant to prior deployments and experience garnered therefrom. Designs, previously developed, and plans, previously developed, are reusable if the collected experience indicates that their reuse is permitted and appropriate.

In another aspect of the present invention, a deployment overview management system is provided that is operable in an active environment in which executing objects encapsulate metadata attributes. The executing objects are embodied at common, or different, processing architectures. When embodied at different architectures, parallel processing is possible, and the metadata attributes are correspondingly created at an increased rate.

In another aspect of the present invention, a repository is provided for storing collected feedback associated with processes, objects, and prior deployments. Encapsulated, executing code and data objects are further maintained at the repository. The repository-stored information and objects is accessible, and the information and objects thereat are used pursuant to automated object generation and deployment to meet the functionality requirements of executing plans. Objects are substantiated, e.g., using a just-in-time methodology that populates data as saved at a last active state or refreshes data with system or plan defaults.

In another aspect of the present invention, when the deployment overview management system is in a static environment, the system holds a last execution state of its objects, holds either documents or links to documents, and contains contingency data, system settings and defaults. In the event that a recovery environment is required, the static-environment information is utilized.

Improved system deployment is provided as the metadata, collected and maintained, is used in the deployment.

In these and other aspects, therefore, a system, method, and apparatus is provided for facilitating deployment of an object-based computer system. An object repository is maintained with active objects. The active objects have object metadata associated therewith. The object metadata is updated with feedback provided by prior-deployed active objects. Selection is made, using the object metadata, of active objects to be deployed in the object-based computer system.

A more complete appreciation of the scope of the present invention and the manner in which it achieves the above-noted and other improvements can be obtained by reference to the following detailed description of presently-preferred embodiments taken in connection with the accompanying drawings that are briefly summarized below, and by reference to the appended claims.

### BRIEF DESCRIPTION OF THE DRAWINGS

FIG. 1 illustrates an arrangement in which an embodiment of the present invention is operable.

FIG. 2 illustrates a functional block diagram of a representation of a portion of the arrangement shown in FIG. 1, representative of an embodiment of the present invention.

FIG. 3 illustrates a functional block diagram representative of the architecture of an embodiment of the present invention.

FIG. 4 illustrates a method flow diagram representative of the method of operation of an embodiment of the present invention.

### DETAILED DESCRIPTION

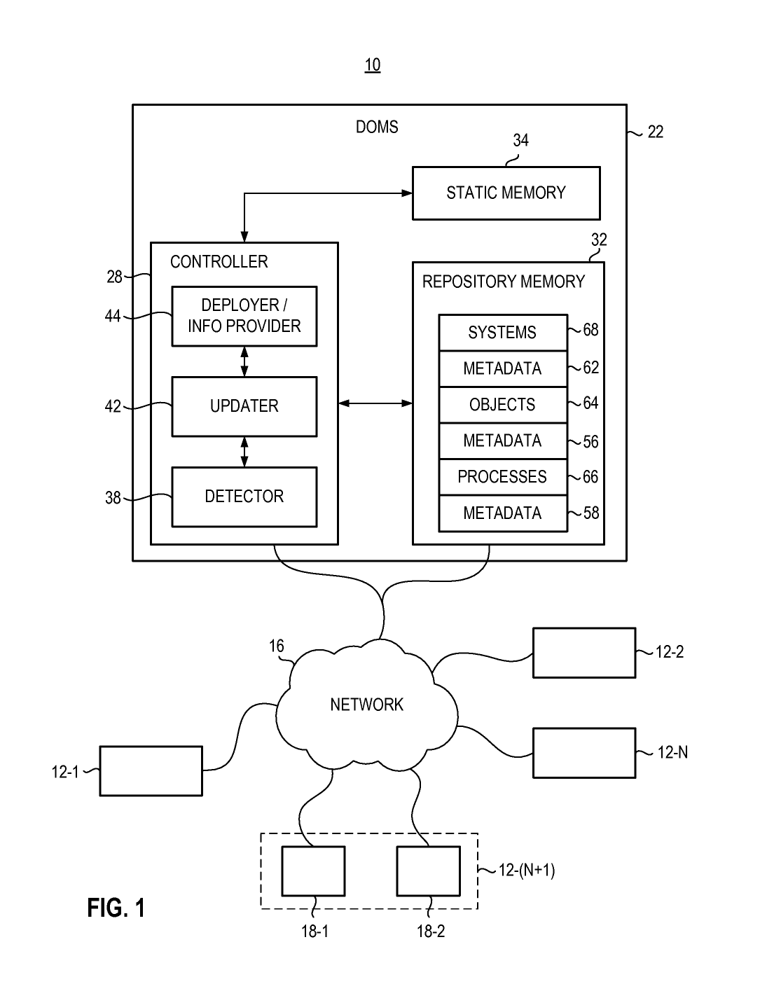

Referring first, therefore, to FIG. 1, an arrangement, shown generally at 10, illustrates a plurality of disparate locations 12 at which computer systems are installed or are installable. Each of the locations is connectable in communication connectivity with a network 16, such as the internet or other wide area network (WAN). The locations 12 are representative, e.g., of the locations of business enterprises, or the like. The locations 12-1, 12-2, and 12-N are representative of single-location enterprises, and the location 12-N+1 is representative of a business enterprise or the like that has multiple, disparate facilities, here 18-1 and 18-2. Personnel at any of the locations operate to create and deploy a computer system thereat.

The arrangement 10 further shows a deployment overview management system (DOMS) 22 of an embodiment of the present invention. The system 22 provides overview of computer-system development and deployment by personnel at any of the locations 12 or directly providers for computer-system deployment and management. The system 22 is functionally represented, implementable in any desired manner, including, e.g., algorithms executable by processing circuitry, hardware implementations, and combinations thereof. The deployment overview management system 22 is also placed in communication connectivity with the network 16, here capable both of receiving and transmitting information from and to computer systems installed at any of the locations 12. Communications are carried out in any conventional manner, including, as a transport medium, Internet Protocol (IP)-formatted data. The system 22 is used pursuant to deployment and management of a computer system, such as a computer system deployable at any of the locations 12. And, the system 22 receives information related to operation of computer systems installed at the locations 12, subsequent to their deployment, during their operation. Advantage is taken of the information received at the system 22 by previously-deployed systems, processes, and objects thereof pursuant to deployment and management operations of the system 22 or its use as an overview of systems deployed by personnel at a location 12.

Here, the system 22 is shown to include a controller 28, a memory 32, and a static memory 34. The controller includes a detector 38, an updater 42, and a deployer 44. While the elements of the system 22 are shown at a single physical location, in another implementation, the elements of the system are distributed across more than one physical location.

The memory 32 forms a repository at which to cache or otherwise store information. Here, the information comprises metadata 56, 58, and 62. The metadata 56 is associated with computer objects 64, i.e., object-oriented software, or other software programs or algorithms that are deployable or deployed in a computer system. The metadata 58 is associated with processes 66 and the metadata 62 is associated with deployed computer systems 68. The contents of the memory 32 are accessible during operation of the system 22. Additionally, the contents of the memory 32 are further storable at the static memory element 34. Metadata, and other information, stored at the static memory element is also retrievable and forms a long-term storage vehicle for storing the metadata, and other information, for lengthy periods. Metadata associated with additional structures and attributes associated with a computer system are also storeable at the memory element forming the repository.

In operation, the detector 38 detects information communicated to the system 22 by computer systems and other devices by way of the network 16. The information includes metadata, such as the types of metadata represented at 56, 58, and 62 of the memory 32. Detections made by the detector are provided to the updater 42. The updater operates to update, or initially to store, metadata associated with objects, processes, or entire, deployed systems. The metadata is, e.g., indexed together with their associated objects, processes, or deployed systems.

The deployer 44 of the system 22 accesses the information stored at the memory 32 and, if needed, the static memory 34. The deployer utilizes the metadata pursuant to deployment selections, e.g., pursuant to decision as to what objects to deploy in a system deployment, etc. The metadata is also retrievable and communicated, such as by way of the deployer, to personnel at selected locations 12 to provide personnel at the locations with information associated with a computer system or any object, process, or other part thereof. Providing of such information to personnel is carried out, e.g., by way of a query and reply sequence.

By making use of the metadata that is collected and stored at the repositories formed of the memory 32 and the memory 34, improved selection, based upon experience garnered from actual operations of earlier-deployed, and other, systems is provided. More efficient deployments, resolution of problems, and advice or instructions to personnel associated with a computer system or its deployment are all provided.

The deployment overview management system effectively forms an overview controller of other deployment systems. The system 22 is based on maintaining an active repository, formed at the memory element 32 of the metadata 56, 58, and 62 in the context of each deployment. The system 22 provides documentation support, e.g., templates, guides, etc., for manual tasks. The system 22 further generates scripts and action automated tasks, collects, analyzes, and reports progress to personnel, such as control boards, and monitors performance of processes, e.g., timesheets, reporting tools, etc. Through the collection, maintenance, retrieval, and usage of the metadata, the performance of deployment systems and processes is better matched to expectations and, where appropriate, contingency actions and plans are activated and coordinated.

The system coordinates, optimizes, and controls a complete deployment process, using multiple sub-systems over multiple platforms in diverse geographical locations. The system 22 acts as a facilitator in deployments using teams separated by geography and across language barriers.

Feedback is provided, generated by computer systems positioned at any of the locations 12, or elsewhere, in communication connectivity with the system 22. Each iteration of feedback of each process, object, or system builds up stored experience and provides, e.g., for predictive analysis of time-to-do processes, cost simulation, resource and capacity planning, and other predictive analytic operations are performable.

In one implementation, the experience, i.e., feedback, is captured and maintained in order to provide SME (small and medium enterprises) collections of, e.g., work arounds, tips to follow, etc. System experience maintained at the repository or static memory is retrievable, without delay, and is used to refine a current or future system deployment. Performance information provided as feedback to the system 22 is, e.g., associated with individual items of metadata. New implementation strategies are able to leverage previous work by re-using designs and plans, prepared during prior deployments.

The system 22 is an active environment that is based on executing objects that encapsulate appropriate metadata attributes. Advantage is taken of parallel processing architectures.

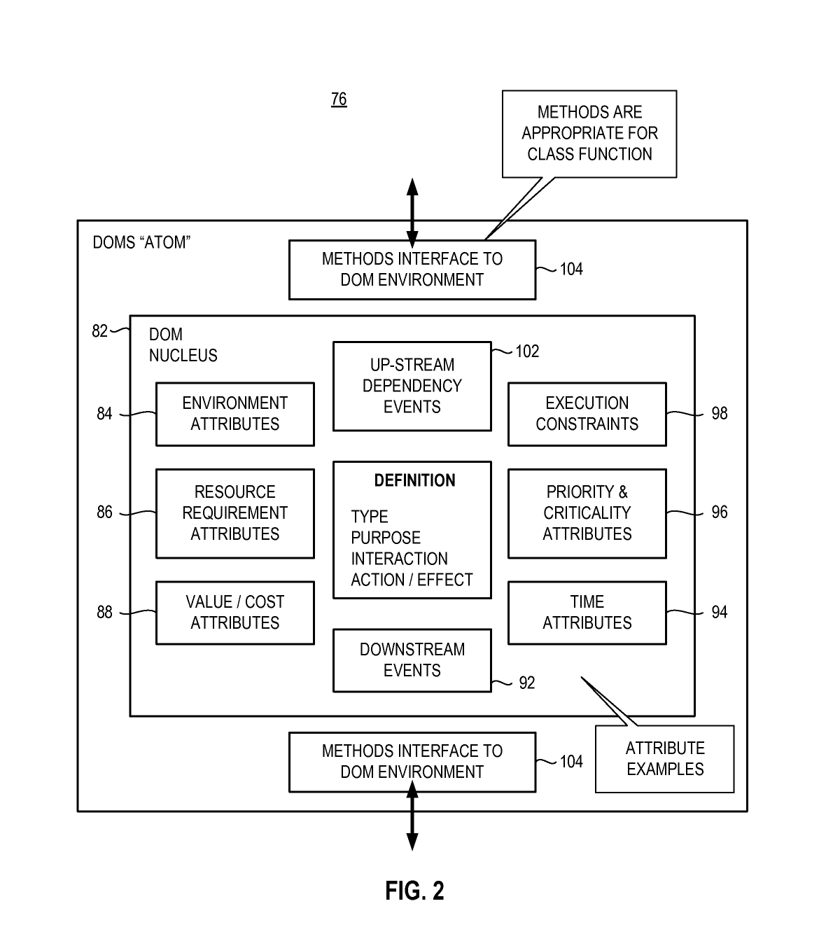

FIG. 2 illustrates a representation, shown at 76, representative of a deployment overview management system “Atom”. The DOMS Atom is the smallest process that can be assigned, tracked, or otherwise recognized as an event or to have a measurable effect on a process. The DOMS Atom is a building block defined in the system. As shown, the Atom 76 includes a nucleus 82. The nucleus comprises a set of attributes, here shown to include environment attributes 84, resource requirement attributes 86, value/cost attributes 88, downstream events 92, time attributes 94, priority and criticality attributes 96, execution constraints 98, and up-stream dependency events 102.

Methods that enact behavior and interface to other system objects and processes are here referred to as DOMS electrons and are shown at 104, methods interfaced to the DOM environment.

DOMs Atoms 76 are subject to inheritance to add or to modify behavior and are combinable with other Atoms to create processes. When processes are combined, the combined processes form plans. Combined plans form strategies, and strategies combine to form campaigns. Combinations of campaigns form alliances. And, a complex deployment plan is therefore ultimately based upon the interactions of simple DOMs objects.

When a deployment plan is undergoing development, active objects execute and provide instant feedback that becomes available almost immediately to deployment personnel. A rapid application development (RAD) environment is thereby facilitated. Continual assessment of impacts to executing deployments is able to be undertaken as the deployments are executed, thereby to report issues and permit automatic activation of contingencies prior to issues becoming critical.

Additionally, each successive elaboration of a developing plan builds on simple and tested behavior of the constituent parts of the plan.

The repository formed of the memory element 32, shown in FIG. 1, includes a collection of encapsulated, executing code/data objects. A repository is scalable, if needed, to increase its capacity. For instance, when the repository is embodied at a server, an increase in the memory of the server, or an addition of an additional server provides for the increased size capacity of the repository. New functionality can be added to the system 22 through the use of inheritance techniques, and new objects can be added to the system without the need to modify or replace existing objects. The DOMS processes are independent, asynchronous utilities that include functions including, e.g., maintenance of system availability, static storage backup of the metadata at the static memory element 34, monitoring, reporting, and servicing user requirements.

In one implementation, the DOMS 22 includes an object manager that is charged with automated object generation and deployment to meet functionality requirements of executing plans. Objects are substantiating using a just-in-time methodology, which populates data as saved at the last active state or refreshes data with system or plan defaults. In one implementation, DOMS objects are unsubstantiated when not required according to system settings and re-use requirements. The object manager is usable in conjunction with other agents to optimize server execution, its performance, and additionally ensures optimal resource and power usage.

Feedback, and other information and data loaded to the system 22 is parsed, encapsulated, and deployed. Controllers execute DOM object methods in order to extract data for use by sub-systems. Requirements that enhance reporting and data extractions are enacted through the exploitation of object, reuse through inheritance techniques, or by adding new objects without the need to change the environment of the DOM system 22.

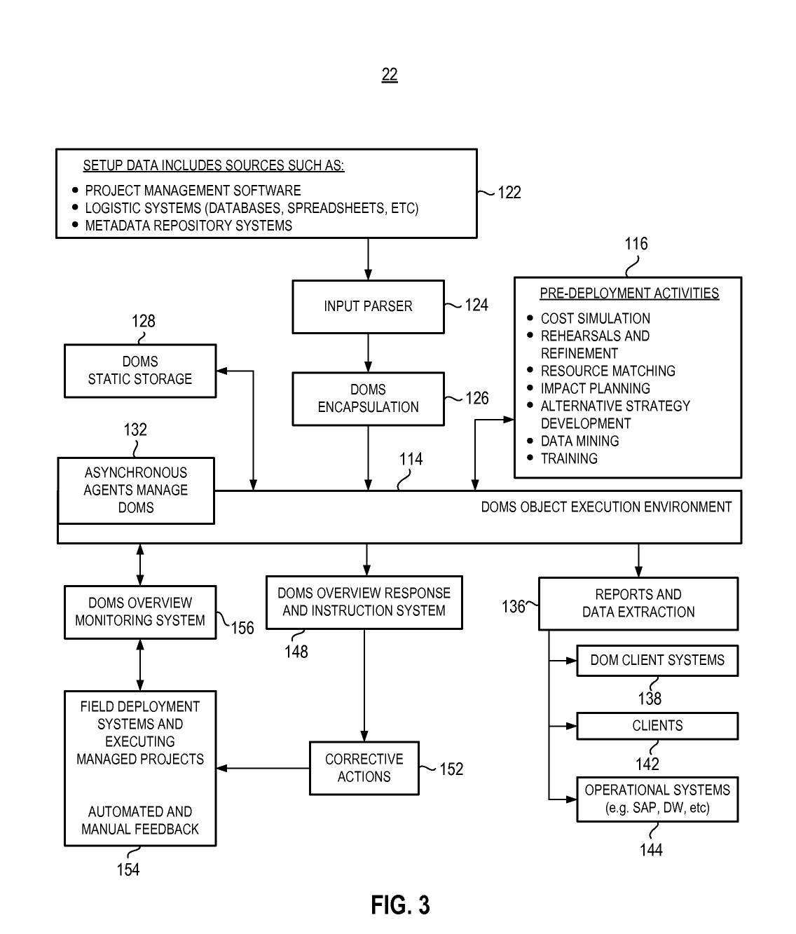

FIG. 3 illustrates an exemplary architecture of the deployment overview management system 22 of an embodiment of the present invention. The architecture defines a DOMs object execution environment 114. Pre-deployment activities 116 are indicated to include cost simulation, rehearsals and refinement, resource matching, impact planning, alternative strategy development, data mining, and training, each of which is executable at the DOMs object execution environment.

Additionally, the architecture indicates provisioning of setup data 122. The setup data includes sources such as project management software, logistic systems, e.g., databases, spreadsheets, etc., and metadata repository systems. The setup data is parsed by an input parser 124 encapsulated by DOMs encapsulation indicated at 126 and provided to the environment 114. The execution environment further is capable of accessing a static storage 128. And, the architecture further illustrates asynchronous agents 132 operable to manage the DOMs.

Responsive to object execution at the execution environment 114, reports are generated and data is extracted, indicated at 136. The reports and extracted data are for DOM client systems 138, other clients 142, and operational systems 144.

Additionally responsive to object execution at the execution environment 114, a DOMs overview response and instruction system operates. Corrective actions, indicated at 152 are performable upon field deployment systems and executing managed projects, indicated at 154 and automated and manual feedback is provided, here, e.g., to an overview and monitoring system 156.

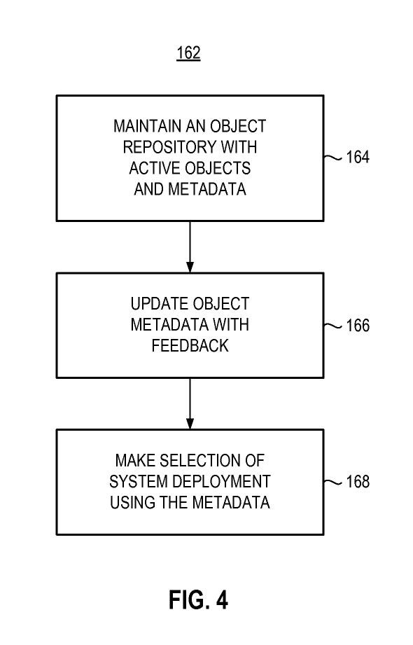

FIG. 4 illustrates a method flow diagram, shown generally at 162, representative of the method of operation of an embodiment of the present invention. The method facilitates deployment and management of an object-based computer system.

First, and as indicated by the block 164, an object repository with active objects is maintained. The active objects have object metadata associated therewith.

Then, and as indicated by the block 166, the object metadata is updated with feedback provided by prior-deployed, active objects of prior system deployments. And, as indicated by the block 168, system-deployment selection is made using the metadata that is maintained and updated.

System deployment is facilitated by taking advantage of reported experiences, reported by way of feedback to the deployment overview management system, of other deployed systems.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. A method for facilitating deployment of an object-based computer system, said method comprising:
maintaining an object repository with active objects, the active objects having object metadata associated therewith;
updating the object metadata with feedback provided by prior-deployed, active objects of a prior system deployment; and
selecting, using the object metadata, active objects to be deployed in the object-based computer system.

2. The method of claim 1 further comprising deploying the active objects selected during said selecting pursuant to deployment of the object-based computer system.

3. The method of claim 1 wherein said maintaining further comprises maintaining process metadata associated with the prior system deployments and wherein said selecting further uses the process metadata.

4. The method of claim 1 wherein said updating comprises updating the object metadata with feedback provided during execution of the prior-deployed active objects of the prior system deployment.

5. The method of claim 1 wherein said selecting further comprises selecting activation of a contingency to the prior system deployment responsive to the object metadata updated during said updating.

6. The method of claim 1 wherein said selecting comprises multiple selection iterations to select the active objects to be deployed n the object-based computer system, each selection iteration using updated object metadata.

7. The method of claim 1 further comprising generating an active object to be deployed in the object-based computer system.

8. The method of claim 1 further comprising monitoring interaction between prior-deployed active objects.

9. The method of claim 8 wherein said updating comprises updating the object metadata with feedback formed responsive to said monitoring.

10. The method of claim 1 further comprising automatically providing feedback, the feedback automatically provided used to update the object metadata.

11. The method of claim 1 further comprising backing up the object metadata to a static storage element.

12. The method of claim 1 further comprising performing a system deployment simulation.

13. The method of claim 1 further comprising analyzing trends using the object metadata.

14. An apparatus for facilitating object-based computer system deployment, said apparatus comprising:
an object repository configured to store object metadata associated with active objects;
an updated configured to update the object metadata stored at said object repository; and
a selector configured to select, using the object metadata, active objects to be deployed pursuant to the object-based computer system deployment.

15. The apparatus of claim 14 wherein said object repository is further configured to store process metadata associated with prior system deployments.

16. The apparatus of claim 14 wherein said object repository is further configured to store active objects.

17. The apparatus of claim 16 further comprising a deployer configured to deploy the active objects selected by said selector.

18. The apparatus of claim 14 wherein said updated is configured to update the object metadata with feedback provided by prior-deployed active objects of a prior system deployment.

19. The apparatus of claim 14 wherein said selector is configured to make multiple selection iterations to select the active objects to be deployed in the object-based computer system, each selection iteration using updated object metadata.

20. A method for managing multiple, deployed systems, said method comprising:
maintaining a repository of metadata associated with each deployed system of the multiple, deployed systems;
updating the metadata maintained at the repository using feedback provided by the multiple, deployed systems; and
using the metadata to alter a deployed system of the multiple deployed systems.
